(19) United States
(12) Patent Application Publication
(10) Pub. No.: US 2024/0130387 A1
(43) Pub. Date: Apr. 25, 2024

(54) HIGH PROTEIN ANALOG CHEESE USING PEA STARCH AND METHODS FOR MAKING SUCH ANALOG CHEESE

(71) Applicant: CORN PRODUCTS DEVELOPMENT, INC., Westchester (IL)

(72) Inventors: Jay SANGHANI, Bridgewater, NJ (US); Adrianne SPERANZA, Bridgewater, NJ (US); Matthew YURGEC, Bridgewater, NJ (US)

(21) Appl. No.: 17/769,399

(22) PCT Filed: Oct. 19, 2020
(86) PCT No.: PCT/US2020/056461

§ 371 Date: Apr. 14, 2022

Related U.S. Application Data
(60) Provisional application No. 62/924,964, filed on Oct. 23, 2019.

(51) Int. Cl. A23C 20/02

(52) U.S. Cl. CPC A23C 20/025

(57) ABSTRACT

This specification discloses high protein analog cheese having protein content greater than about 10% by weight. Such analog cheeses comprise pea starch and one more pulse protein isolate or pulse protein concentrate and have a firmness of greater than about 5000 g. Also, disclosed are methods of making analog cheese that avoid separation during processing. Such methods include applying reduced shear as the process progresses and heating a final mixture for a short time and at low speed.

### CROSS-REFERENCE TO RELATED APPLICATIONS

This is an international PCT application which claims the benefit of U.S. Provisional Patent Application No. 62/924,964, filed 23 Oct. 2019, which is incorporated by reference herein in its entirety.

The specification pertains to analog cheeses and more particularly to high protein analog cheeses.

Analog cheese, as used in this specification, is a non-dairy food composition intended to mimic a dairy cheese. The described analog cheeses include a plant protein source and other ingredients which combined are intended to provide the functionality of dairy cheese. While analog cheese is known, because plant proteins functions differently than milk protein, present analog cheese products do not provide equivalent protein content to dairy cheese. At least in part this is because at higher protein content it has proved difficult to avoid ingredient separation during analog cheese making, including for example oil separation.

The technology disclosed in this specification pertains to high protein analog cheese and method of making such products. In any embodiment, an analog cheese, as described in this specification has a protein content greater than about 10% by weight or greater than about 11% or greater than about 12% or from about 10% to about 15%, from about 10% to about 13% by weight. Such analog cheese has firmness that is like that of dairy cheese. In any embodiment, an analog cheese, as described in this specification has firmness of greater than about 5000 g, or greater than about 6000 g, from about 5000 g to about 7000 g.

In any embodiment, an analog cheese, as described in this specification includes a starch component. In any embodiment, a starch component of an analog cheese contains all starch within the analog cheese. In any embodiment starch component of an analog cheese consists of native starch. In any embodiment, an analog cheese as described in this specification does not comprise a modified starch. In any embodiment starch component of an analog cheese consists of native pea starch in an amount greater than about 4% by weight, or greater than about 6%, or greater than about 8%, or from about 4% to about 15% or from about 4% to about 12% or from about 6% to about 12% or from about 8% to about 12%. In any embodiment described in this specification an analog cheese comprises a pea starch having an apparent amylose content of from about 30% to about 40% or about 35%.

In any embodiment an analog cheese, as described in this specification, comprises pea starch as the sole native starch in a starch component for the purpose of increasing the firmness of an analog cheese compared to analog cheese using other native or modified starches. In any embodiment, a test analog cheese as described in this specification using a native pea starch has greater than 1.25 times the firmness of a comparative test analog cheese using a native starch other than pea starch, or greater than about 1.5 times, or greater than about 1.6 times, or greater than about 1.75 times, or greater than about 2 times, or greater than about 3 times. In any embodiment, a test analog cheese as described in this specification using a native pea starch has greater than 1.25 times the firmness of a comparative test analog cheese using an oxidized potato starch, or greater than about 1.5 times, or greater than about 1.6 times, or greater than about 1.75 times, or greater than about 2 times, or greater than about 2.25 times. In any embodiment, a test analog cheese as described in this specification using a native pea starch has greater than 1.25 times the firmness of a comparative test analog cheese using a native starch 50% amylose corn starch, or greater than about 1.5 times, or greater than about 1.6 times, or greater than about 1.75 times, or greater than about 2 times.

In any embodiment, a test analog cheese as described in this specification using a native pea starch has less oil separation during processing than a test analog cheese using a native starch other than a pea starch. In any embodiment a composition for making an analog cheese comprising native pea starch can be obtained using higher protein content without oil separation being evident than the same composition for making an analog cheese comprising a native starch that is not native pea starch.

In any embodiment of an analog cheese, as described in this specification the protein content of the analog cheese is supplied by a protein component. In any embodiment a protein component for use in an analog cheese, as described in this specification, consists of one or more pulse proteins. Pulse proteins useful for making an analog cheese include but are not limited pea protein, lentil protein, chickpea protein, and fava bean protein. In any embodiment of an analog cheese described in this specification the protein is provided as a pulse protein isolate. In any embodiment, an analog cheese, as described in this specification includes a pea protein in an amount of at least about 5% by weight or at least about 7.5% or at least about 10%, or of from about 5% to about 15% or from about 7.5% to about 12%. In any embodiment, an analog cheese includes a fava bean protein in an amount of at least about 5% by weight or at least about 7.5% or at least about 10%, or of from about 5% to about 15% or from about 7.5% to about 12%. In any embodiment, an analog cheese, as described in this specification includes a pulse protein isolate or a pulse protein concentrate, or a mixture of two pulse protein isolates, or a mixture of pulse protein concentrate and a pulse protein isolate, or a mixture of two pulse protein concentrates. In any embodiment, an analog cheese, as described in this specification includes a protein component having a fava bean protein isolate and a pea protein in a ratio of about 66:33, or about 60:40, or about 50:50, or about 33:66, or about 40:60, or about 25:75. In any embodiment, an analog cheese, as described in this specification includes a protein component, which contains all of the protein in the analog cheese, and which consists of a mixture of a fava bean protein isolate and a pea protein isolate.

In any embodiment, an analog cheese includes a pea starch, a protein component and a third ingredient. A third ingredient may be a liquid ingredient for example, an oil (including but not limited to coconut oil, or other vegetable oil), or water or salt, or an acidulant, for example including but not limited to lactic acid. In any embodiment, an analog cheese as described in this specification has a moisture content of from about 50% to about 60% or from about 50% to about 58% or from about 50% to about 54%. A third ingredient may be a hydrocolloid or a gum, or may be gum acacia, xanthan gum, locust bean gum, konjac gum, guar gum, and agar and mixtures thereof. A third ingredient may be salt or lactic acid, or another flavoring agent.

The technology disclosed in this specification pertains to methods of making an analog cheese. In any embodiment, a method of making an analog cheese, as described in this specification includes (a) mixing a first mixture comprising water, a plant protein component, and a pea starch at a first mixing rate, (b) mixing at second mixing rate, which is less than the first mixing rate, an oil and the first mixture to form a second mixture, (c) mixing at a third mixing rate, which is less than the second mixing rate, lactic acid with the second mixture to form a third mixture, (d) heating the third mixture and (e) allowing the third mixture to cool. In any embodiment, a method for making an analog cheese, as described in this specification includes hydrating a gum or mixture of gums in an aqueous solution at a first mixing rate.

In any embodiment, a method for making an analog cheese, as described in this specification includes mixing a mixture at a first mixing rate of from about 750 to about 4000 revolutions per minute (“RPM”) RPM, or from about 1000 to about 3500 RPM, or from about 1500 to about 3000 RPM or from about 2000 to about 3000 RPM, or from about 2500 to about 3000 RPM. In any embodiment, a method for making an analog cheese, as described in this specification includes mixing a mixture at a second mixing rate of from about 750 RPM to about 3000 RPM, or from about 1000 RPM to about 2500 RPM, or from about 1000 RPM to about 2000 RPM or from about 1000 RPM to about 1500 RPM. In any embodiment, a method for making an analog cheese, as described in this specification includes mixing a mixture at a third mixing rate of from about 500 RPM to about 2000 RPM, or from about 500 RPM to about 1500 RPM, or from about 500 RPM to about 1000 RPM.

In any embodiment, a method for making an analog cheese, as described in this specification includes heating a mixture for from about 60 to about 300 seconds, or from about 60 to about 240 seconds, or from about 60 to about 180 seconds, or from about 60 to about 120 seconds, or from about 60 to about 90 seconds. In any embodiment, a method for making an analog cheese, as described in this specification includes mixing a mixture at from about 500 RPM to about 2000 RPM, or from about 500 RPM to about 1500 RPM, or from about 500 RPM to about 1000 RPM while heating the mixture. In an embodiment, a method of making an analog cheese, as described in this specification, heats a mixture at a temperature of from about 80° to about 99° C., or from about 85° to about 95° C., or from about 90° C. to about 95°. In any embodiment, of the methods described in this specification a mixture is heated by applying direct or indirect heat, either using for example but not limited to electrical heating or steam heating or other method of heating the mixture within the mixer.

In any embodiment, a method of making an analog cheese as described in this specification is useful for making an analog cheese from any formulation described in this specification. In any embodiment, a method of making an analog cheese, as described in this specification substituting on a one for one basis a native pea starch for all native starch, such methods being useful for preventing separation of liquid and solid ingredients during making the analog cheeses, and being useful for increasing the firmness of an analog cheese.

Reference in this specification to “analog cheese” refers to a non-dairy food composition intended to mimic dairy cheese. The analog cheese described in this specification may mimic any target dairy cheese in texture and flavor, but in some embodiments analog cheese is intended to mimic semi-soft to hard cheese including for example commercially available Cheddar cheese sticks or cubes.

Reference in this specification to a “test analog cheese” means an analog cheese product having the formula of Table 1.

TABLE 1
Recipe of Test Analog Cheese

| Ingredients | % Usage |
|---|---|
| Water | 55.81 |
| Coconut Oil (refined) | 21.75 |
| Fava Bean Protein | 4.17 |
| Concentrate | |
| Pea Protein Isolate | 11.22 |
| TICALOID ® 620* | 0.75 |
| Starch | 4.00 |
| Lactic Acid | 1.30 |
| Salt | 1.00 |
| Total | 100.00 |

*TICALOID ® 620 is a mixture of gums sold by Ingredion Incorporated.

Reference in this specification to “a test method of making an analog cheese” means use of the following method to make an analog cheese from the formula for making a test analog cheese. 1) Mix gum hydrated in water in a cooking mixer (e.g. from Stephan Machinery) for 2 minutes at 3000 RPM; 2) add remaining dry ingredients (protein, starch, and salt) and blend for 2 minutes at 3000 RPM; 3) add oil and mix for 2 minutes at 1500 RPM; 4) add lactic acid and blend for 45 seconds at 750 RPM; 5) heat mixture using direct steam to 201° F. (about 94° C.) and hold for 75 seconds at 750 RPM; and 6) collect product and cool.

Reference in this specification to a “pulse protein isolate” means a composition obtained from a milled pulse that is substantially plant protein. Pulses, which are the seeds of legumes, include peas, fava beans, chickpeas, and lentils, among other things. Pulses, as seeds, comprise starch, protein, and fiber, and frequently (but not necessarily) comprise greater than 50% starch and only around 30% protein. Once milled, the components of the pulse flour can be separated to be substantially pure. Within this specification, a pulse protein isolate comprises greater than about 75% protein by weight.

Reference in this specification to a “pulse protein concentrate” means a composition obtained from a milled pulse that is has increased plant protein content than would the unmilled pulse but less protein than a protein isolate. Within this specification, a pulse protein concentrate comprises from about 50% to less than about 75% protein by weight.

Reference in this specification to “native starch” means granular, unmodified starch. Starch being obtained by milling starch-containing plant parts may comprise trace amounts of other materials including but not limited to protein and fiber. Native starches for use in analog cheese are food grade starches and have starch content of at least about 98% starch by weight.

Within this specification, firmness is measured using a texture analyzer. In any embodiment, measurements can be made on refrigerated (about 4° C.) blocks of analog cheese having height of about 17 to 18 millimeters or cores of analog cheese samples. In any embodiment a sample can be measured using the following procedure: measure sample using a TAXT II Plus Texture Analyzer and Exponent software equipped with a 30 kg load cell by a two-compression test with TA-25 25 mm aluminum cylinder probe (8 mm/sec pre-test, test, and post-test speed, 10 mm compression distance, 2 second test rate, 10 g trigger force).

Use of “about” to modify a number in this specification is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” in this specification is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The technology is further described in the following aspects, which are intended to be illustrative, and are not intended to limit the full scope of the claims and their equivalents.

In a first aspect, the technology disclosed in this specification pertains to an analog cheese comprising protein content greater than about 10% by weight or greater than about 11% or greater than about 12% or from about 10% to about 15%, from about 10% to about 13% by weight, and a native pea starch in an amount greater than about 4% by weight, or greater than about 6%, or greater than about 8%, or from about 4% to about 15% or from about 4% to about 12% or from about 6% to about 12% or from about 8% to about 12%.

In a second aspect, the technology disclosed in this specification pertains to the analog cheese of the first aspect wherein the cheese has a firmness of greater than about 5000 g, or greater than about 6000 g, or from about 5000 g to about 7000 g.

In a third aspect, the technology disclosed in this specification pertains to the analog cheese of the first or second aspect wherein the protein content is from a pulse protein.

In a fourth aspect, the technology disclose in this specification pertains to the analog cheese of any one of the first to third aspect wherein the protein is provided as a protein component comprising a pea protein (as a first pulse protein) and protein in an amount of at least about 5% by weight or at least about 7.5% or at least about 10%, of from about 5% to about 15% or from about 7.5% to about 12% and a second pulse protein.

In a fifth aspect, the technology disclosed in this specification pertains to the analog cheese of any one of the first to fourth aspects wherein the protein is provided as a protein component comprising a fava bean protein in an amount of at least about 5% by weight or at least about 7.5% or at least about 10%, of from about 5% to about 15% or from about 7.5% to about 12% and a second pulse protein.

In a sixth aspect, the technology disclosed in this specification pertains to the analog cheese of any one of the first to fifth aspects wherein the protein is provided as a protein component consisting of one of a pea protein and a mixture of a fava bean protein and a pea protein, and optionally wherein the fava bean protein and pea protein are used in a ratio of from 66:33 (fava bean to pea), or about 60:40, or about 50:50, or about 33:66, or 40:60, or about 25:75.

In a seventh aspect, the technology disclosed in this specification pertains to the analog cheese of any one of the first to sixth aspects further having a moisture content of from about 50% to about 60% or from about 50% to about 58% or from about 50% to about 54%.

In an eighth aspect, the technology disclosed in this specification pertains to the analog cheese of any one of the first to seventh aspects further comprising a gum selected from the group consisting of acacia, xanthan, locust bean and mixtures thereof.

In a ninth aspect, the technology disclosed in this specification pertains to the analog cheese of any one of the first to eighth aspects, which does not comprise a modified starch.

In a tenth aspect, the technology disclosed in this specification pertains to a method of making an analog cheese comprising (a) mixing a first mixture comprising water, a plant protein component, and a pea starch at a first mixing rate, (b) mixing at second mixing rate, which is less than the first mixing rate, an oil and the first mixture and to form a second mixture, (c) mixing at a third mixing rate, which is less than the second mixing rate, lactic acid with the second mixture to form a third mixture, (d) heating the third mixture at a temperature of from about 80° to about 99° C., or from about 85° to about 95° C., or from about 90° C. to about 95° C. and (e) allowing the third mixture to cool, optionally wherein the analog cheese has a protein content of greater than about 10% by weight or greater than about 11% or greater than about 12% or from about 10% to about 15%, from about 10% to about 13% by weight.

In an eleventh aspect, the technology disclosed in this specification pertains to the method of the tenth aspect wherein the pea starch is used in an amount greater than about 4% by weight, or greater than about 6%, or greater than about 8%, or from about 4% and about 15% or from about 4% to about 12% or from about 6% to about 12% or from about 8% to about 12%.

In a twelfth aspect, the technology disclosed in this specification pertains to the method of the tenth or eleventh aspects wherein protein component consists of a fava bean protein and a pea protein, and optionally wherein the fava bean protein and pea protein are used in a ratio of from 66:33, or about 60:40, or about 50:50, or about 33:66, or 40:60, or about 25:75.

In a thirteenth aspect, the technology disclosed in this specification pertains to the method of any one of the tenth to twelfth aspects further comprises, prior to mixing the first mixture, hydrating a gum in an aqueous solution at the first mixing rate.

In a fourteenth aspect, the technology disclosed in this specification pertains to the method of any one of the tenth to thirteenth wherein the gum selected from the group consisting of acacia, xanthan, locust bean and mixtures thereof.

In a fifteenth aspect, the technology disclosed in this specification pertains to the method of any one of the tenth to fourteenth aspects wherein the first mixing rate is from about 750 to about 4000 RPM, or from ab out 1000 to about 3500 RPM, or from about 1500 to about 3000 RPM or from about 2000 to about 3000 RPM, or from about 2500 to about 3000 RPM.

In a sixteenth aspect, the technology disclosed in this specification pertains to the method of any one of the tenth to fifteenth aspects wherein the second mixing rate is from about 750 RPM to about 3000 RPM, or from about 1000 RPM to about 2500 RPM, or from about 1000 RPM to about 2000 RPM or from about 1000 RPM to about 1500 RPM.

In a seventeenth aspect, the technology disclosed in this specification pertains to the method of any one of the tenth to sixteenth aspects wherein the third mixing rate is from about 500 RPM to about 2000 RPM, or from about 500 RPM to about 1500 RPM, or from about 500 RPM to about 1000 RPM.

In an eighteenth aspect, the technology disclosed in this specification pertains to the method of any one of the tenth to seventeenth aspects wherein the mixture is heated for from about 60 to about 300, or from about 60 to about 240 seconds, or from about 60 to about 180 seconds, or from about 60 to about 120 seconds, or from about 60 to about 90 seconds.

In a nineteenth aspect, the technology disclosed in this specification pertains to the use of a native pea starch as described in any foregoing claims to increase the firmness of a high protein analog cheese.

In a twentieth aspect, the technology disclosed in this specification pertains a method for increasing the firmness of an analog cheese comprising: (a) a starch component of native starches, the method comprising substituting on a one for one basis a native pea starch for all native starch, and (b) making an analog cheese using a method comprising (i) mixing a first mixture comprising water, a plant protein component, and a pea starch at a first mixing rate, (ii) mixing at second mixing rate, which is less than the first mixing rate, an oil and the first mixture and to form a second mixture, (iii) mixing at a third mixing rate, which is less than the second mixing rate, lactic acid with the second mixture to form a third mixture, (iv) heating the third mixture at a temperature of from about 80° to about 99° C., or from about 85° to about 95° C., or from about 90° C. to about 95° C. and (v) allowing the third mixture to cool, optionally wherein the analog cheese has a protein content of greater than about 10% by weight or greater than about 11% or greater than about 12% or from about 10% to about 15%, from about 10% to about 13% by weight.

In a twenty-first aspect, the technology disclosed in this specification pertains to the twentieth aspect wherein the analog cheese is a test analog cheese that was made by a test method of making an analog cheese, and wherein the test analog cheese comprising pea starch has greater than 1.25 times the firmness of a comparative test analog cheese using a native starch other than pea starch, or greater than about 1.5 times, or greater than about 1.6 times, or greater than about 1.75 times, or greater than about 2 times, or greater than about 3 times.

In a twenty-second aspect, the technology disclosed in this specification pertains to the method of claims twenty or twenty-first aspects wherein the analog cheese is a test analog cheese that was made by a test method of making an analog cheese, and wherein the test analog cheese comprising pea starch has greater than 1.25 times the firmness of a comparative test analog cheese using a native starch 50% amylose corn starch, or greater than about 1.5 times, or greater than about 1.6 times, or greater than about 1.75 times, or greater than about 2 times. The technology is further described by the following examples, which are intended to be illustrative and are not intended to limit the full scope of the claims or their equivalents.

### EXAMPLE 1—METHOD OF MAKING ANALOG CHEESE

Analog cheeses were made using various starches and various amount of starch and were evaluated for firmness using refrigerated (about 4° C.) blocks of analog cheese having heights of about 17 to 18 millimeters. Samples were measured using a TAXTII Plus Texture Analyzer and Exponent software equipped with a 30 kg load cell by a two-compression test with TA-25 25 mm aluminum cylinder probe (8 mm/sec pre-test, test, and post-test speed, 10 mm compression distance, 2 second test rate, 10 g trigger force).

An analog cheese was made as follows. Gum mix was hydrated in water in a cooking mixer available from Stephan Machinery for 2 minutes at 3000 RPM. Remaining dry ingredients (protein, starch, and salt) were added and the mixture was blended for 2 minutes at 3000 RPM. Oil was added and mixed for 2 minutes at 1500 RPM. Lactic acid was added and blended for 45 seconds at 750 RPM. The mixture was heated using direct steam to 201° F. (about 94° C.) and held for 75 seconds at 750 RPM. The product was collected and cooled.

### EXAMPLE 2—EFFECT OF STARCH TYPE ON ANALOG CHEESE FIRMNESS

The formula reported in Table 2 was used to make 11.5% protein analog cheeses.

TABLE 2
Formula for High Protein Analog Cheese

| | % | % | % | % | Wt. |
|---|---|---|---|---|---|
| Ingredients | Usage | Protein | Fat | Solids | (g) |
| Water | 55.81 | 0.00 | 0.00 | 0.00 | 5581.00 |
| Coconut Oil (refined) | 21.75 | 0.00 | 21.53 | 21.75 | 2175.00 |
| Fava Bean Protein | 4.17 | 2.50 | 0.15 | 4.04 | 417.00 |
| Concentrate | | | | | |
| Pea Protein Isolate | 11.22 | 8.98 | 0.02 | 10.88 | 1122.00 |
| TICALOID ® 620 | 0.75 | 0.00 | 0.00 | 0.66 | 75.00 |
| (gum mix) | | | | | |
| Starch | 4.00 | 0.00 | 0.00 | 3.52 | 400.00 |
| Lactic Acid | 1.30 | 0.00 | 0.00 | 0.00 | 130.00 |
| Salt | 1.00 | 0.00 | 0.00 | 1.00 | 100.00 |
| Total | 100.00 | 11.48 | 21.70 | 41.86 | 10000.00 |

Using the formula of Table 2 and foregoing method, analog cheeses were made using various starches. The analog cheeses were measured for firmness. The results are reported in Table 3.

TABLE 3
Firmness of Analog Cheese Made from Various Starch

| Sample No. | Starch | Firmness (g) |
|---|---|---|
| 1 | Native Pea Starch | 5454 |
| 2 | Native Tapioca Starch | 2660 |
| 3 | Thermally Inhibited Potato Starch | 3362 |
| 4 | Native Rice Starch | 1677 |
| 5 | Native Corn Starch | 2348 |
| 6 | Native Potato Starch | 3552 |
| 7 | Native 50% Amylose Corn Starch | 2777 |
| 8 | Oxidized Potato Starch (Control) | 2285 |
| 9 | Crosslinked Potato Starch (Control) | 5496 |

As shown in Table 3 analog cheeses made from native pea starch (Sample 1) were firmer from analog cheeses made using other native starches (2, 4-7). Also as shown, the analog cheeses made from native pea starch had similar firmness to starches made from crosslinked potato starch, but were firmer than analog cheeses made using oxidized potato starch.

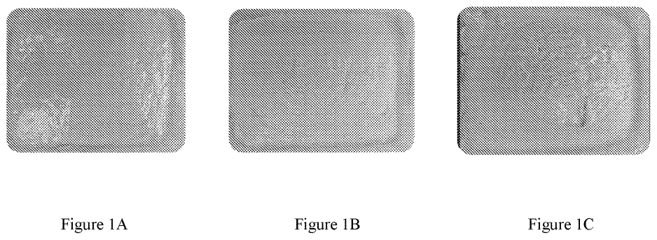

Also, it was observed that during processes analog cheese batters made using pea starch suffered from less oil separation than was observed for analog cheese using native potato starch or native tapioca starch. With reference to FIGS. 1A, 1B, and 1C this can be seen in the oil sheen on the FIG. 1A (potato starch) and FIG. 1C (tapioca starch) samples, which is not seen on the pea starch sample, FIG. 1B.

### EXAMPLE 2—EFFECT OF INCREASING PEA STARCH ON HARDNESS

Analog cheeses using various amounts of pea starch were made using the formula of Table 1 except water content was reduced to account for increased pea starch. For example a 6% pea starch analog cheese used 53.8% water, and an analog cheese made using 8% pea starch had 51.8% water. The firmness of analog cheese using 4%, 6%, and 8% pea protein is reported in Table 4.

TABLE 4
Analog Cheese Using Various Amounts of Pea Starch

| Sample No. | % Pea starch | Firmness (g) |
|---|---|---|
| 10 | 4% Pea Starch | 5311 |
| 11 | 6% Pea Starch | 5821 |
| 12 | 8% Pea Starch | 6011 |

### EXAMPLE 3—EFFECT OF PROTEIN CONTENT ON HARDNESS

Analog cheeses using various proteins and protein amounts were analyzed for firmness. All samples were made from formulations based on that of Table 2 but with reduced amounts of water as protein content increased. Table 5 shows the effect of increasing protein content while maintaining the ratio of pea protein to fava bean protein.

TABLE 5
Pea Protein Analog Cheeses - Varying Protein Amounts

| Sample No. | % Pea starch | Firmness (g) |
|---|---|---|
| 13 | 11.5% Protein | 5311 |
| 14 | 12.8% Protein | 5002 |

Notable as protein content increases, and so solids content increase, analog cheese firmness does not necessarily increase.

1. An analog cheese comprising:
protein content greater than about 10%, and
a native pea starch in an amount greater than about 4% by weight.

2. The analog cheese of claim 1 wherein the cheese has a firmness of greater than about 5000 g.

3. The analog cheese of claim 1 wherein the protein content is from a pulse protein.

4. The analog cheese claim 1 wherein the protein is provided as a protein component comprising the pea protein and second pulse protein in an amount of at least about 5% by weight.

5. The analog cheese of claim 1 of wherein the protein is provided as a protein component comprising a fava bean protein in an amount of at least about 5% by weight.

6. The analog cheese of claim 1 wherein the protein is provided as a protein component consisting of a mixture of a fava bean protein and a pea protein,
wherein the fava bean protein and pea protein are used in a ratio of from 66:33 (fava bean to pea), to about 25:75.

7. The analog cheese of claim 1 further having a moisture content of from about 50% to about 60%.

8. The analog cheese of claim 1 further comprising a gum selected from the group consisting of acacia, xanthan, locust bean and mixtures thereof.

9. The analog cheese of claim 1 which does not comprise a modified starch.

10. A method of making an analog cheese comprising:
(a) mixing a first mixture comprising water, a plant protein component, and a pea starch at a first mixing rate,
(b) mixing at second mixing rate, which is less than the first mixing rate, an oil and the first mixture and to form a second mixture,
(c) mixing at a third mixing rate, which is less than the second mixing rate, lactic acid with the second mixture to form a third mixture,
(d) heating the third mixture at a temperature of from about 80° to about 99° C., or from about 85° to about 95° C., or from about 90° C. to about 95° C. and
(e) allowing the third mixture to cool,
wherein the analog cheese has a protein content of greater than about 10% by weight.

11. The method of claim 10 wherein the pea starch is used in an amount greater than about 4% by weight.

12. The method of claim 10 wherein protein component consists of a fava bean protein and a pea protein, used in a ratio of about 66:33 (fava bean protein to pea protein, to about 25:75.

13. The method of claim 10 further comprises, prior to mixing the first mixture, hydrating a gum in an aqueous solution at the first mixing rate.

14. The method of claim 10 wherein the gum selected from the group consisting of acacia, xanthan, locust bean and mixtures thereof.

15. The method of claim 10 wherein the first mixing rate is from about 750 to about 4000 RPM.

16. The method of claim 10 wherein the second mixing rate is from about 750 RPM to about 3000 RPM.

17. The method of claim 10 wherein the third mixing rate is from about 500 RPM to about 2000 RPM.

18. The method of claim 10 wherein the mixture is heated for from about 60 to about 300 seconds.

19-22. (canceled)
